(19) United States
(12) Patent Application Publication
(10) Pub. No.: US 2026/0118540 A1
(43) Pub. Date: Apr. 30, 2026

(54) LOW SIGNAL-TO-NOISE RATIO SEISMIC DETECTION MODEL BASED ON DEEP RESIDUAL SHRINKAGE NETWORK

(71) Applicant: CHENGDU UNIVERSITY OF TECHNOLOGY, CHENGDU (CN)

(72) Inventors: BIN XU, CHENGDU (CN); HUAN CAO, CHENGDU (CN); CONGYU WANG, CHENGDU (CN); SHAO WANG, CHENGDU (CN); XIAOXIANG ZHAO, CHENGDU (CN); JUN FENG, CHENGDU (CN); QUANFENG WANG, CHENGDU (CN); YANFANG ZHANG, CHENGDU (CN)

(21) Appl. No.: 19/186,562

(22) Filed: Apr. 22, 2025

(30) Foreign Application Priority Data
Oct. 30, 2024 (CN) 202411525410.8

(51) Int. Cl. G01V 1/36

(52) U.S. Cl. CPC G01V 1/364; G01V 2210/324; G01V 2210/70

(57) ABSTRACT

The present invention discloses a low signal-to-noise ratio (SNR) seismic event detection model based on a deep residual shrinkage network (DRSN). Considering the different noises contained in seismic records acquired by different seismic sensors, a DRSN based on a residual network was constructed to detect seismic events from low SNR seismic records. In the constructed network, a soft thresholding function (a shrinkage function) was inserted into the deep network structure as a nonlinear transform layer to effectively filter the impact of noise-related features, and an attention mechanism, together with an adaptive soft thresholding block, was also incorporated to automatically obtain the optimal denoising threshold for seismic signals, which ensures different signals are processed to the best effect. After training, the DRSN adaptively determines the denoising threshold so that each seismic signal has its own threshold set and seismic events can be accurately detected under strong background noise.

### TECHNICAL FIELD

The present invention belongs to the technical field of seismic detection, in particular to a low signal-to-noise ratio (SNR) seismic detection model based on a deep residual shrinkage network (DRSN).

### BACKGROUND

Seismic event detection, which refers to the process of recognizing seismic events from continuous seismic records, is the core of observational seismology. Aftershock monitoring and rapid localization following a major earthquake, tomography of the Earth's internal velocity structure, and seismic cataloging all rely on seismic event detection. With the continuous expansion of seismic networks and mobile arrays, the involved seismic observation data are increasing explosively. Detecting seismic events from massive seismic records simply based on human-computer interactions is no longer cater to the intelligent processing of seismic data in the big-data era. Therefore, the challenge of automatically and accurately detecting seismic events from seismic records has become an urgent issue in seismic data processing.

Among existing technologies, deep learning-based methods have achieved certain results in seismic event detection. However, they are highly sensitive to the quality of seismic data. Generally, better detection results are achieved for seismic records with a higher SNR, but for seismic records with a low SNR, e.g., the microseismic events—which are extremely weak in energy and sometimes even down to the noise level—the detection results tend to be unsatisfactory. Given the complexity and variability of the seismic observation environment, the seismic records acquired are always accompanied by various noises that compromise the detection accuracy.

Therefore, signals must be denoised before detection. Commonly used methods in signal denoising include wavelet threshold denoising and empirical mode decomposition. These algorithms first transform the raw signal to a domain where the near-zero numbers are unimportant and then use a thresholding function to convert the near-zero features to zeros, thus removing noise. Their denoising threshold is typically kept unchanged. However, because the noises contained in seismic records acquired by different seismic sensors are dramatically different, the denoising performance is not ideal, especially for low SNR seismic records. Notably, for seismic event detection, inappropriate denoising leads to poor detection performance, especially for microseismic events.

Designing an appropriate thresholding function is key to signal denoising. To improve denoising performance, a soft thresholding function has been introduced in many seismic signal denoising algorithms. However, how to identify the right soft thresholding function is a significant challenge requiring extensive expertise in seismic signal processing. Furthermore, as the noises (including noise intensities) contained in seismic records acquired by different seismic sensors are different, the optimal thresholding function differs among different signals, making the design more difficult.

### SUMMARY

The present invention aims to provide a low SNR seismic detection model based on a DRSN. Considering the different noises contained in seismic records acquired by different seismic sensors, a DRSN was constructed on the basis of designing a soft threshold function and introducing an attention mechanism to detect seismic events in low SNR seismic records. To realize the above purpose, the technical scheme adopted by the present invention is as follows:

The low SNR seismic detection model based on a DRSN, wherein the following steps:
A. Construct the DRSN. Stacking a given number of residual shrinkage building units based on an adaptive soft thresholding block (RSBU-ASTBs), a convolutional layers, a batch normalization (BN) layers, a rectified linear unit (ReLU) activation functions, a global average pooling (GAP) layers, and a fully connected (FC) layers yields a complete DRSN.
A1. A soft thresholding function (a shrinkage function) is inserted into the deep network structure as a nonlinear transform layer to effectively filter the impact of noise-related features on seismic event detection.
A2. An attention mechanism, together with an adaptive soft threshold block (ASTB), is incorporated to automatically obtain the optimal threshold for denoising seismic signals and process different signals to the best effect.
B. Test the detection performance of the DRSN under different SNR conditions.

Furthermore, in step A, first, a seismic signal with the size of C×W×1 is inputted, where C is the number of channels, W is width, and 1 is height of a seismic signal. As the input is the seismic wave amplitude signal, the height of the feature map is constantly 1. Then, the features of each channel are extracted using two convolutional layers. To prevent overfitting and enhance the nonlinear expression capability of the model, the BN and ReLU activation functions are added before each convolution operation.

Furthermore, in step A, the convolutional layer is used to extract the features of the input object, and it involves multiplying the output feature map of the previous layer with the convolution kernel according to a given rule, as expressed in the following formula:

$${y}_{j}^{l} = {\sum }_{i ∈ {M}_{j}} {x}_{i}^{l - 1} * {k}_{ij}^{l} + {b}_{j}^{l} , \\ where {y}_{j}^{l} \qquad ( 1 )$$

is the jth feature of the lth layer in the output feature map, xₗ_{ₗ}⁻ⁱ is the ith feature of the (l−1)th layer in the input feature map,

$${k}_{ij}^{l}$$

is the convolution kernel,

$${b}_{j}^{l}$$

is the bias, * is the convolution operation, and Mⱼ is the input data used for calculating the jth feature.

Furthermore, in step A, after the features of the input object are extracted through the convolutional layer, the involved data are normalized through the BN processing to improve the convergence speed and generalization capability of the neural network. The BN first normalizes the inputs for the subsequent layer by calculating their mean and variance to obtain data with uniform distribution and then introduces the stretching parameter γ and offset parameter β to restore the feature distribution learned by the network layer. The calculation process of the BN is expressed as follows:

$$μ = \frac{1}{m} {\sum }_{i = 1}^{m} {x}_{i} , \qquad ( 2 )$$

$${σ}^{2} = \frac{1}{m} {\sum }_{i = 1}^{m} {( {x}_{i} - μ )}^{2} , \qquad ( 3 )$$

$${\hat{x}}_{i} = \frac{{x}_{i} - μ}{\sqrt{{σ}^{2} + ε}} , \qquad ( 4 )$$

$${y}_{i} = γ {\hat{x}}_{i} + β , \qquad ( 5 )$$

where xᵢ and yᵢ are the input and output features of the ith sample in a minibatch, respectively; m is the number of samples in a minibatch; ε is a small positive constant close to 0 to ensure the denominator is not 0; and γ and β are trainable parameters used to scale and shift the distributions.

Furthermore, after the BN of the extracted features, the soft thresholding block (STB) is used to estimate the denoising threshold, and the adaptive slope block (ASB) automatically infers the most suitable slope for the signal with the attention mechanism and further corrects this threshold against the inferred slope.

Furthermore, when using a STB to estimate the threshold, the one-dimensional vector of the absolute value for the feature map is first obtained using the GAP. This vector is passed into the two FC layers to obtain the scale parameter α_{c}, which is scaled to (0, 1) with the sigmoid function. α_{c} is calculated using the following formula:

$${α}_{c} = \frac{1}{1 + {e}^{- {z}_{c}}} , \qquad ( 6 )$$

where z_{c} is the feature of the cth layer of neurons. Multiplying the scale parameter with the absolute value of the one-dimensional feature vector derives the threshold τ_{c}, which is expressed as follows:

$${τ}_{c} = {α}_{c} \cdot {average}_{i , j , c} \vert {x}_{i , j , c} \vert , \qquad ( 7 )$$

where i,j, and c are the width, height, and channel of feature map x, respectively.

Furthermore, meanwhile, an attention mechanism is used in the ASB to automatically infer the most suitable slope for the signal. The output is expressed as follows:

$$β = \frac{1}{1 + {e}^{- {q}_{c}}} , \qquad ( 8 )$$

where β is the adaptive slope factor, and q_{c} is the feature of the cth layer of neurons.

Therefore, the output τ_{c} of the STB is corrected with adaptive slope factor β to obtain the optimal soft thresholding. According to the optimal soft thresholding, features with smaller absolute values are deleted, and those with larger absolute values are shrunk toward 0. The soft thresholding function is expressed as follows:

$$y = \{ \begin{matrix}β ( x - {τ}_{c} ) & x > {τ}_{c} \\ 0 & - {τ}_{c} \leq x \leq {τ}_{c} \\ β ( x + {τ}_{c} ) & x < - {τ}_{c}\end{matrix} , \qquad ( 9 )$$

where x and y are the input signal and its optimal soft thresholding, respectively.

Furthermore, in step B, randomly selected 75,000 seismic events and noise signals from the Stanford earthquake dataset (STEAD) and divided them into training, validation, and test sets with ratios of 80%, 10%, and 10%, respectively, to train the model, adjust the hyperparameters, and test the detection performance of the DRSN.

Furthermore, when training the model, the batch size and maximum epoch are set. The cross-entropy error function was used to calculate the distance between the actual model output and label, and the network was optimized through adaptive moment estimation (learning rate=0.0001) to reduce the error function value. After repeated training and optimization trials, the error of the training result was minimized, the model converged, and the optimal model was obtained. The cross-entropy error is calculated using the following formula:

$$E = - {\sum }_{j = 1}^{n} {t}_{j} log ( {e}^{{x}_{j}} / {\sum }_{i = 1}^{n} {e}^{{x}_{i}} ) , \qquad ( 10 )$$

where xᵢ is the ith output feature map, tⱼ is the probability of the sample belonging to the jth class, n is the number of classes, E is the value of the cross-entropy error function.

Furthermore, upon completion of the training, the test set is employed to validate the constructed seismic event detection model.

Compared with the prior art, the present invention has the advantage that the accuracy of seismic detection under low SNR conditions is improved by constructing a DRSN. In this network, a soft thresholding function (a shrinkage function) was inserted into the deep network structure as a nonlinear transform layer to effectively filter the impact of noise-related features, and an attention mechanism, together with an ASTB, was also incorporated to automatically obtain the optimal denoising threshold for seismic signals, which ensures different signals are processed to the best effect. After training, the DRSN adaptively determines the denoising threshold so that each seismic signal has its own threshold set and ensuring accurate detection of seismic events under strong background noise.

### BRIEF DESCRIPTION OF THE DRAWINGS

In order to more clearly illustrate the technical solutions in the specific embodiments or related art of the present disclosure, the accompanying drawings to be used in the description of the specific embodiments or related art will be briefly introduced below, and it will be obvious that the accompanying drawings in the following description are some of the embodiments of the present disclosure, and that for those skilled in the art, other drawings are obtained on the basis of the accompanying drawings without putting in creative labor.

FIG. 1 is a flowchart of the low SNR seismic detection model based on a DRSN provided by the present invention.

FIG. 2 is a graph of a seismic event and a noise signal in the STEAD (experimental data 1) of the low SNR seismic detection model based on a DRSN provided by the present invention.

FIG. 3 is the accuracy and loss function curves of the model training process for the low SNR seismic detection model based on a DRSN provided by the present invention.

FIG. 4 is the confusion matrix of each method for the STEAD.

FIG. 5 is the ROC curve of each method for the STEAD.

FIG. 6 is a graph of a seismic event and a noise signal in the microseismic monitoring data (experimental data 2) of the low SNR seismic detection model based on a DRSN provided by the present invention.

FIG. 7 is the confusion matrix of each method for microseismic signals.

FIG. 8 is the ROC curve of each method for microseismic signals.

### DETAILED DESCRIPTION OF THE EMBODIMENTS

In order to more clearly illustrate the technical solutions in the specific embodiments or related art of the present disclosure, the accompanying drawings to be used in the description of the specific embodiments or related art will be briefly introduced below, and it will be obvious that the accompanying drawings in the following description are some of the embodiments of the present disclosure, and that for those skilled in the art, other drawings are obtained on the basis of the accompanying drawings without putting in creative labor.

It should be noted that similar labels and letters indicate similar items in the following accompanying drawings, so that once an item has been defined in one accompanying drawing, it does not need to be further defined and explained in subsequent accompanying drawings.

In the description of the present invention, it should be noted that if terms such as “center,” “upper,” “lower,” “left,” “right,” “vertical,” “horizontal,” “inner,” “outer,” etc., are used to indicate orientations or positional relationships, these are based on the orientations or positional relationships shown in the accompanying drawings, or the conventional orientations or positional relationships in which the product of the present invention is typically used. These terms are used solely for the purpose of facilitating the description of the invention and simplifying the explanation, and do not imply or suggest that the described device or component must have a specific orientation or be constructed and operated in a specific orientation. Therefore, such terms should not be construed as limiting the scope of the present invention.

Additionally, terms such as “first,” “second,” “third,” etc., are used solely for the purpose of distinguishing descriptions and should not be interpreted as indicating or implying relative importance.

In addition, the terms “horizontal”, “vertical”, “overhanging”, etc., when they appear, do not mean that the parts are required to be absolutely horizontal or overhanging, but are slightly inclined. For example, “horizontal” simply means that its orientation is more horizontal than “vertical” and does not mean that the structure must be perfectly horizontal, but are slightly inclined.

In the description of the present invention, it should also be noted that, unless otherwise expressly specified and limited, the terms “set up”, “mounted”, “connected”, etc. are to be understood in a broad sense, “connected”, etc. should be understood in a broad sense, for example, it can be a fixed connection, a removable connection, or a connection in one piece; it can be a mechanical connection or an electrical connection; it can be a direct connection or an indirect connection through an intermediate medium, and it can be a connection within the two elements. For a person of ordinary skill in the art, the specific meaning of the above terms in the context of the present invention are understood in specific cases.

It is noted that features in embodiments of the present invention are combined with each other without conflict.

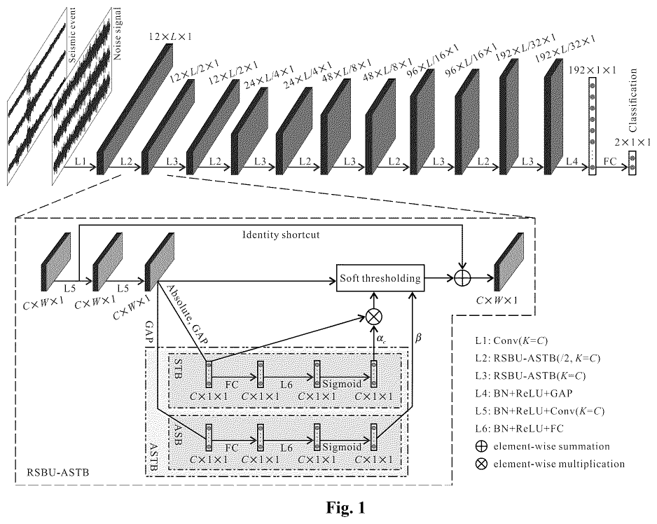

As shown in FIG. 1, the low SNR seismic detection model based on a DRSN, includes the following steps:

A. Construct the DRSN. Stacking a given number of RSBU-ASTBs, convolutional layers, BN layers, ReLU activation functions, GAP layers, and FC layers yields a complete DRSN.

First, a seismic signal with the size of C×W×1 is inputted, where C is the number of channels, W is width, and 1 is height of a seismic signal. As the input is the seismic wave amplitude signal, the height of the feature map is constantly 1. Then, the features of each channel are extracted using two convolutional layers. To prevent overfitting and enhance the nonlinear expression capability of the model, the BN and ReLU activation functions are added before each convolution operation.

The convolutional layer is used to extract the features of the input object, and it involves multiplying the output feature map of the previous layer with the convolution kernel according to a given rule, as expressed in the following formula:

$${y}_{j}^{l} = {\sum }_{i ∈ {M}_{j}} {x}_{i}^{l - 1} * {k}_{ij}^{l} + {b}_{j}^{l} , where {y}_{j}^{l} \qquad ( 1 )$$

is the jth feature of the lth layer in the output feature map, xₗ_{ₗ}⁻ⁱ is the ith feature of the (l−1)th layer in the input feature map,

$${k}_{ij}^{l}$$

is the convolution kernel,

$${b}_{j}^{l}$$

is the bias, * is the convolution operation, and Mⱼ is the input data used for calculating the jth feature.

After the features of the input object are extracted through the convolutional layer, the involved data are normalized through the BN processing to improve the convergence speed and generalization capability of the neural network. The BN first normalizes the inputs for the subsequent layer by calculating their mean and variance to obtain data with uniform distribution and then introduces the stretching parameter γ and offset parameter β to restore the feature distribution learned by the network layer. The calculation process of the BN is expressed as follows:

$$μ = \frac{1}{m} {\sum }_{i = 1}^{m} {x}_{i} , \qquad ( 2 )$$

$${σ}^{2} = \frac{1}{m} {\sum }_{i = 1}^{m} {( {x}_{i} - μ )}^{2} , \qquad ( 3 )$$

$${\hat{x}}_{i} = \frac{{x}_{i} - μ}{\sqrt{{σ}^{2} + ε}} , \qquad ( 4 )$$

$${y}_{i} = γ {\hat{x}}_{i} + β , \qquad ( 5 )$$

where xᵢ and yᵢ are the input and output features of the ith sample in a minibatch, respectively; m is the number of samples in a minibatch; ε is a small positive constant close to 0 to ensure the denominator is not 0; and γ and β are trainable parameters used to scale and shift the distributions.

A1. A soft thresholding function (a shrinkage function) is inserted into the deep network structure as a nonlinear transform layer to effectively filter the impact of noise-related features on seismic event detection.

Specifically, after the BN of the extracted features, the STB is used to estimate the denoising threshold, and the ASB automatically infers the most suitable slope for the signal with the attention mechanism and further corrects this threshold against the inferred slope.

When using a STB to estimate the threshold, the one-dimensional vector of the absolute value for the feature map is first obtained using the GAP. This vector is passed into the two FC layers to obtain the scale parameter α_{c}, which is scaled to (0, 1) with the sigmoid function. α_{c} is calculated using the following formula:

$${α}_{c} = \frac{1}{1 + {e}^{- {z}_{c}}} , \qquad ( 6 )$$

where z_{c} is the feature of the cth layer of neurons. Multiplying the scale parameter with the absolute value of the one-dimensional feature vector derives the threshold τ_{c}, which is expressed as follows:

$${τ}_{c} = {α}_{c} \cdot {average}_{i , j , c} \vert {x}_{i , j , c} \vert , \qquad ( 7 )$$

where i,j, and c are the width, height, and channel of feature map x, respectively.

A2. An attention mechanism, together with an ASTB, is incorporated to automatically obtain the optimal threshold for denoising seismic signals and process different signals to the best effect.

Meanwhile, an attention mechanism is used in the ASB to automatically infer the most suitable slope for the signal. The output is expressed as follows:

$$β = \frac{1}{1 + {e}^{- {q}_{c}}} , \qquad ( 8 )$$

where β is the adaptive slope factor, and q_{c} is the feature of the cth layer of neurons.

Therefore, the output τ_{c} of the STB is corrected with adaptive slope factor β to obtain the optimal soft thresholding. According to the optimal soft thresholding, features with smaller absolute values are deleted, and those with larger absolute values are shrunk toward 0. The soft thresholding function is expressed as follows:

$$y = \{ \begin{matrix}β ( x - {τ}_{c} ) & x > {τ}_{c} \\ 0 & - {τ}_{c} \leq x \leq {τ}_{c} \\ β ( x + {τ}_{c} ) & x < - {τ}_{c}\end{matrix} , \qquad ( 9 )$$

where x and y are the input signal and its optimal soft thresholding, respectively.

B. Test the detection performance of the DRSN under different SNR conditions.

In step B, randomly selected 75,000 seismic events and noise signals from the STEAD and divided them into training, validation, and test sets with ratios of 80%, 10%, and 10%, respectively, to train the model, adjust the hyperparameters, and test the detection performance of the DRSN.

When training the model, the batch size and maximum epoch are set. The cross-entropy error function was used to calculate the distance between the actual model output and label, and the network was optimized through adaptive moment estimation (learning rate=0.0001) to reduce the error function value. After repeated training and optimization trials, the error of the training result was minimized, the model converged, and the optimal model was obtained. The cross-entropy error is calculated using the following formula:

$$E = - {\sum }_{j = 1}^{n} {t}_{j} log ( {e}^{{x}_{j}} / {\sum }_{i = 1}^{n} {e}^{{x}_{i}} ) , \qquad ( 10 )$$

where xᵢ is the ith output feature map, tⱼ is the probability of the sample belonging to the jth class, n is the number of classes, E is the value of the cross-entropy error function.

Upon completion of the training, the test set is employed to validate the constructed seismic event detection model.

To verify the detection performance of the DRSN under real low SNR signals, the present invention applied the model to detect microseismic events from the monitoring data of a shale gas development zone in southern Sichuan.

Specifically, as shown in FIG. 1, the present invention stacks a given number of RSBU-ASTBs, convolutional layers, BN layers, ReLU activation functions, GAP layers, and FC layers to yield a complete DRSN. In the DRSN structure, the first component is an input layer for receiving a three-component seismic signal of length L, that is, channel C=3, width W=L, and height H=1. The second component is a convolutional layer with the number of channels=12, kernel size=3, and step length=1. Then, there are five RSBU-ASTB combinations (with the number of channels=12, 24, 48, 96, and 192), each containing two RSBU-ASTBs with step lengths=2 and 1. Finally, the GAP is used to shrink the feature map into a 192×1 one-dimensional vector, and an FC layer is used to recognize seismic events and noise signals. The DRSN is a network that shrinks information in the residual mapping of a deep residual network, which inserts a soft thresholding function into a deep neural network as a nonlinear transform layer and adaptively learns specific threshold for each signal to remove noise-related features through an attention mechanism and a gradient descent algorithm. This improves the capability of the model to learn seismic event features in low SNR seismic signals and enables it to accurately detect seismic events under strong background noise.

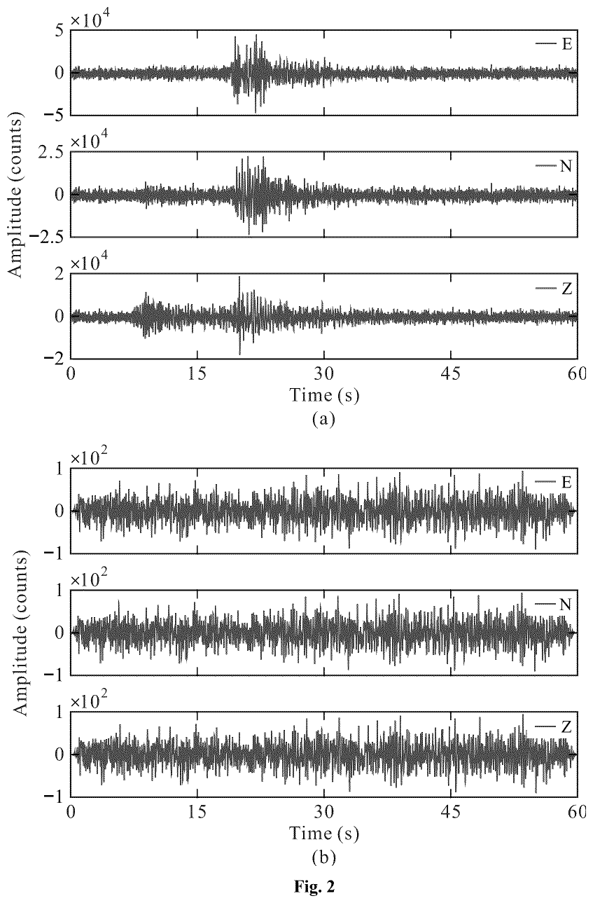

To test the performance of the constructed DRSN, two types of experiments were conducted. Experimental data 1 is the STEAD, which is a global dataset of seismic signals for artificial intelligence comprising more than 1 million data, including seismic events and noise signals, recorded by seismic stations nationwide from January 1984 to August 2018. Each seismic record comprises a 60-s three-component signal sampled at a rate of 100 Hz. The present invention randomly selected 75,000 seismic events and noise signals and divided them into training, validation, and test sets with ratios of 80%, 10%, and 10%, respectively, to train the model, adjust the hyperparameters, and test the detection performance. A seismic event and a noise signal contained in the STEAD are shown in FIG. 2.

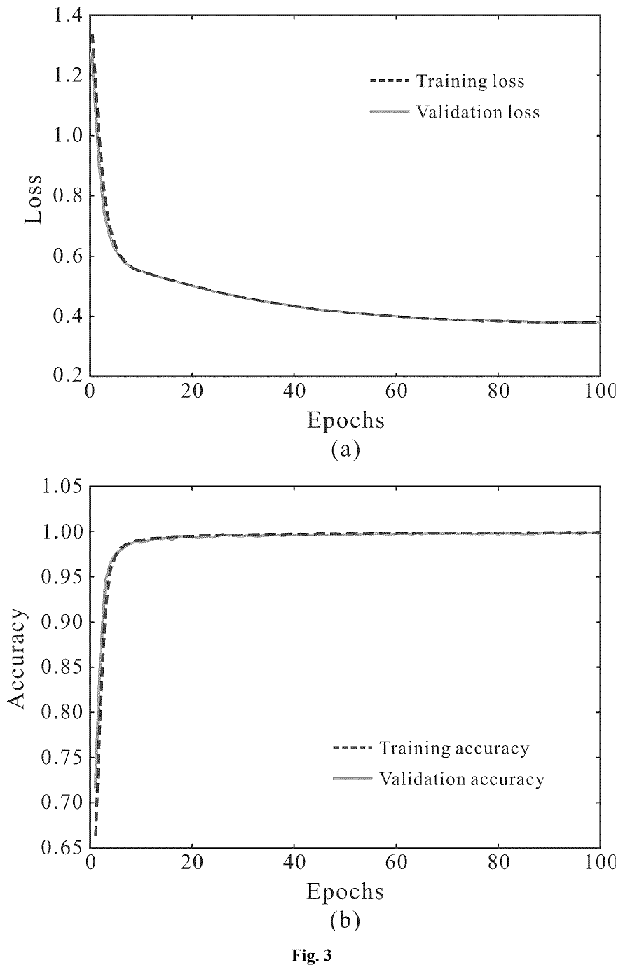

The constructed DRSN was trained using the training set. After repeated training and optimization trials, the error of the training result was minimized, the model converged, and the optimal model was obtained. FIG. 3 shows the accuracy and error function curves of model training. With an increasing number of epochs, the model converged at a higher rate, the training and validation error functions gradually decreased, and the accuracies gradually increased. When iterated to 80 epochs, the error function of the model no longer decreased, and its accuracy no longer increased, indicating that the model was converging. The training and validation error functions of the final model stabilized at 0.390 and 0.392, respectively. The corresponding accuracies stabilized at 99.90% and 99.78%.

Using the trained model, the present invention tested the 15,000 samples in the STEAD that were not involved in model training and validation and compared the detection results with those of the short-term average over long-term average (STA/LTA), convolutional neural network (CNN), earthquake transformer (EQT), and sequential attention network (SEA-net). Table 1 lists the detection results of different methods. Accuracy, precision, recall, and F₁-score are calculated using the following formulas:

$$Accuracy = \frac{TP + TN}{TP + TN + FP + FN} , \qquad ( 11 )$$

$$Precisioin = \frac{TP}{TP + FP} , \qquad ( 12 )$$

$$Recall = \frac{TP}{TP + FN} , \qquad ( 13 )$$

$${F}_{1} - score = 2 \times \frac{Precision \times Recall}{Precision + Recall} , \qquad ( 14 )$$

where TP, TN, FP, and FN are the number of true positive samples (seismic events that were correctly classified as seismic events), true negative samples (noise signals that were correctly classified as noise signals), false positive samples (noise signals that were incorrectly labeled as seismic events), and false negative samples (seismic events that were incorrectly labeled as noise signals), respectively.

TABLE 1
Detection results of different methods based on STEAD.

| Methods | Test samples | TP | FP | FN | TN | Accuracy | Precision | Recall | F₁-score |
|---|---|---|---|---|---|---|---|---|---|
| STA/LTA | 15,000 | 5,749 | 151 | 1,751 | 7,349 | 87.32% | 97.44% | 76.65% | 85.81% |
| CNN | 15,000 | 6,194 | 141 | 1,306 | 7,359 | 90.35% | 97.77% | 82.59% | 89.54% |
| EQT | 15,000 | 7,254 | 116 | 246 | 7,384 | 97.59% | 98.43% | 96.72% | 97.57% |
| SEA-net | 15,000 | 7,282 | 136 | 218 | 7,364 | 97.64% | 98.17% | 97.09% | 97.63% |
| DRSN | 15,000 | 7,364 | 2 | 136 | 7,498 | 99.08% | 99.97% | 98.19% | 99.07% |

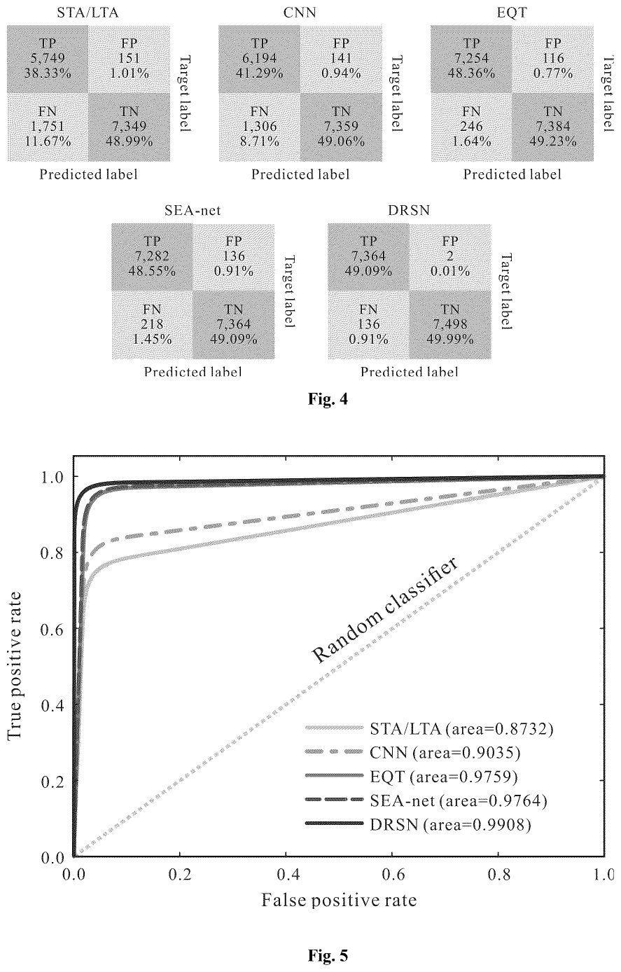

FIGS. 4 and 5 show the comparison of the confusion matrixes and receiver operating characteristic (ROC) curves of the methods. With the trained DRSN, the present invention correctly recognized 14,862 samples and misclassified 136 seismic events as noise signals and 2 noise signals as seismic events, and its accuracy, precision, recall, and F₁-score were 99.08%, 99.97%, 98.19%, and 99.07%, respectively. Overall, the DRSN outperforms any other method in detecting seismic events.

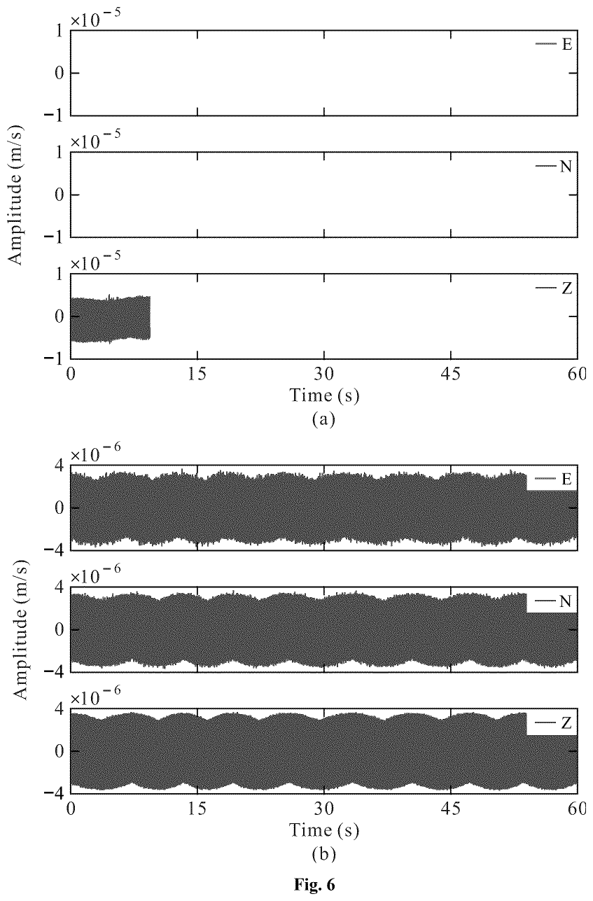

Experimental data 2 comprises microseismic monitoring data of a shale gas development zone in southern Sichuan, where targeting hydraulic-fracturing-induced earthquakes during shale gas extraction, 13 seismometers collected seismic records from February 2017 to July 2018. Each seismic record comprises a 60-s three-component signal sampled at a rate of 250 Hz. Again, the present invention randomly selected 75,000 seismic events and noise signals and divided them into training, validation, and test sets with ratios of 80%, 10%, and 10%, respectively. FIG. 6 shows a seismic event and a noise signal contained in experimental data 2. Compared with natural seismic signals, hydraulic-fracturing-induced microseismic signals have a lower SNR. The interference of background noise nearly overwhelms the microseismic events with weak energy levels.

To verify the detection performance of the DRSN under real low SNR signals, the present invention applied the model to detect microseismic events (experimental data 2) and also compared the results with those of the STA/LTA, CNN, EQT, and SEA-net (Table 2).

TABLE 2
Comparison of detection performances based on microseismic signals.

| Methods | Test samples | TP | FP | FN | TN | Accuracy | Precision | Recall | F₁-score |
|---|---|---|---|---|---|---|---|---|---|
| STA/LTA | 15,000 | 5,033 | 1,003 | 2,467 | 6,497 | 76.87% | 83.38% | 67.11% | 74.36% |
| CNN | 15,000 | 6,038 | 937 | 1,462 | 6,563 | 84.01% | 86.57% | 80.51% | 83.43% |
| EQT | 15,000 | 6,607 | 332 | 893 | 7,198 | 91.85% | 95.22% | 88.09% | 91.52% |
| SEA-net | 15,000 | 6,797 | 265 | 703 | 7,235 | 93.55% | 96.25% | 90.63% | 93.35% |
| DRSN | 15,000 | 7,063 | 249 | 437 | 7,251 | 95.43% | 96.59% | 94.17% | 95.37% |

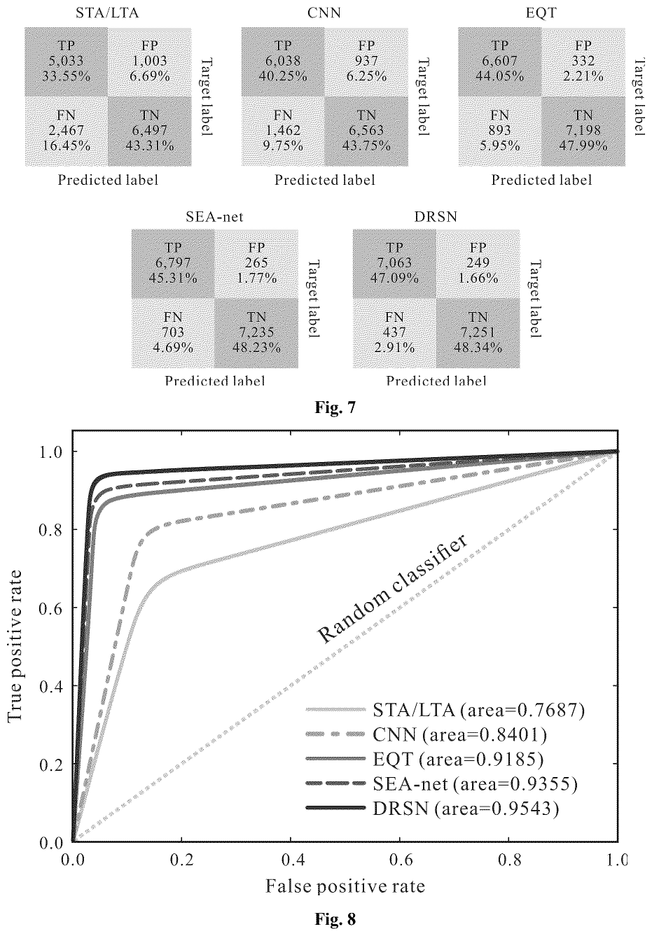

Table 2 and FIGS. 7 and 8 show that all deep learning models outperformed the STA/LTA in seismic event detection, the same trend as for the detection results in the STEAD. The DRSN performed the best, having correctly recognized 14,314 samples and misclassified 437 seismic events as noise signals and 249 noise signals as seismic events, with the accuracy, precision, recall, and F₁-score of 95.43%, 96.59%, 94.17%, and 95.37%, respectively. Hence, the DRSN outperforms all other methods, whether in the case of the high SNR STEAD or low SNR hydraulic-fracturing-induced microseismic signals.

The above embodiments are only intended to illustrate the technical solution of the present disclosure, but not to limit it; although the present disclosure has been described in detail with reference to the foregoing embodiments, those skilled in the art should understand that it is still possible to modify the technical solution recorded in the foregoing embodiments, or to replace some or all of the technical features therein with equivalent ones; and these modifications or substitutions do not take the essence of the corresponding technical solutions out of the scope of the technical solutions of the embodiments of the present disclosure.

What is claimed is:

1. A low signal-to-noise ratio (SNR) seismic detection model based on a deep residual shrinkage network (DRSN), wherein the following steps:
A: Construct the DRSN, stacking a given number of residual shrinkage building units based on an adaptive soft thresholding block (RSBU-ASTBs), a convolutional layers, a batch normalization (BN) layers, a rectified linear unit (ReLU) activation functions, a global average pooling (GAP) layers, and a fully connected (FC) layers yield a complete DRSN,
A1: A soft thresholding function (a shrinkage function) is inserted into the deep network structure as a nonlinear transform layer to effectively filter the impact of noise-related features on seismic event detection,
A2: An attention mechanism, together with an adaptive soft thresholding block (ASTB), is incorporated to automatically obtain the optimal threshold for denoising seismic signals and process different signals to the best effect,
B: Test the detection performance of the DRSN under different SNR conditions.

2. The low SNR seismic detection model based on a DRSN according to claim 1, wherein in step A, first, a seismic signal with the size of C×W×1 is inputted, where C is the number of channels, W is width, and 1 is height of a seismic signal, as the input is the seismic wave amplitude signal, the height of the feature map is constantly 1, then, the features of each channel are extracted using two convolutional layers, to prevent overfitting and enhance the nonlinear expression capability of the model, the BN and the ReLU activation functions are added before each convolution operation.

3. The low SNR seismic detection model based on a DRSN according to claim 2, wherein in step A, the convolutional layer is used to extract the features of the input object, and it involves multiplying the output feature map of the previous layer with the convolution kernel according to a given rule, as expressed in the following formula:
$${y}_{j}^{l} = {\sum }_{i ∈ {M}_{j}} {x}_{i}^{l - 1} * {k}_{ij}^{l} + {b}_{j}^{l} , \qquad ( 1 )$$
$$where {y}_{j}^{l}$$
is the jth feature of the lth layer in the output feature map, x₁_{₁}⁻ⁱ is the ith feature of the (l−1)th layer in the input feature map,
$${k}_{ij}^{l}$$
is the convolution kernel,
$${b}_{j}^{l}$$
is the bias, * is the convolution operation, and Mⱼ is the input data used for calculating the jth feature.

4. The low SNR seismic detection model based on a DRSN according to claim 3, wherein in step A, after the features of the input object are extracted through the convolutional layer, the involved data are normalized through the BN processing to improve the convergence speed and generalization capability of the neural network, the BN first normalizes the inputs for the subsequent layer by calculating their mean and variance to obtain data with uniform distribution and then introduces the stretching parameter γ and offset parameter β to restore the feature distribution learned by the network layer, the calculation process of the BN is expressed as follows:
$$μ = \frac{1}{m} {\sum }_{i = 1}^{m} {x}_{i} , \qquad ( 2 )$$
$${σ}^{2} = \frac{1}{m} {\sum }_{i = 1}^{m} {( {x}_{i} - μ )}^{2} , \qquad ( 3 )$$
$${\hat{x}}_{i} = \frac{{x}_{i} - μ}{\sqrt{{σ}^{2} + ε}} , \qquad ( 4 )$$
$${y}_{i} = γ {\hat{x}}_{i} + β , \qquad ( 5 )$$
where xᵢ and yᵢ are the input and output features of the ith sample in a minibatch, respectively; m is the number of samples in a minibatch; ε is a small positive constant close to 0 to ensure the denominator is not 0; and γ and β are trainable parameters used to scale and shift the distributions.

5. The low SNR seismic detection model based on a DRSN according to claim 4, wherein after the BN of the extracted features, a soft thresholding block (STB) is used to estimate the denoising threshold, and an adaptive slope block (ASB) automatically infers the most suitable slope for the signal with the attention mechanism and further corrects this threshold against the inferred slope.

6. The low SNR seismic detection model based on a DRSN according to claim 5, wherein when using the STB to estimate the threshold, the one-dimensional vector of the absolute value for the feature map is first obtained using the GAP, this vector is passed into the two FC layers to obtain the scale parameter α_{c}, which is scaled to (0, 1) with the sigmoid function, α_{c} is calculated using the following formula:
$${α}_{c} = \frac{1}{1 + {e}^{- {z}_{c}}} , \qquad ( 6 )$$
where z_{c} is the feature of the cth layer of neurons, multiplying the scale parameter with the absolute value of the one-dimensional feature vector derives the threshold τ_{c}, which is expressed as follows:
$${τ}_{c} = {α}_{c} \cdot {average}_{i , j , c} \vert {x}_{i , j , c} \vert , \qquad ( 7 )$$
where i, j, and c are the width, height, and channel of feature map x, respectively.

7. The low SNR seismic detection model based on a DRSN according to claim 6, wherein meanwhile, an attention mechanism is used in the ASB to automatically infer the most suitable slope for the signal, the output is expressed as follows:
$$β = \frac{1}{1 + {e}^{- {q}_{c}}} , \qquad ( 8 )$$
where β is the adaptive slope factor, and q_{c} is the feature of the cth layer of neurons,
therefore, the output τ_{c} of the STB is corrected with adaptive slope factor β to obtain the optimal soft thresholding, according to the optimal soft thresholding, features with smaller absolute values are deleted, and those with larger absolute values are shrunk toward 0, the soft thresholding function is expressed as follows:
$$y = \{ \begin{matrix}β ( x - {τ}_{c} ) & x > {τ}_{c} \\ 0 & - {τ}_{c} \leq x \leq {τ}_{c} \\ β ( x + {τ}_{c} ) & x < - {τ}_{c}\end{matrix} , \qquad ( 9 )$$
where x and y are the input signal and its optimal soft thresholding, respectively.

8. The low SNR seismic detection model based on a DRSN according to claim 7, wherein in step B, randomly selected 75,000 seismic events and noise signals from the Stanford earthquake dataset (STEAD) and divided them into training, validation, and test sets with ratios of 80%, 10%, and 10%, respectively, to train the model, adjust the hyperparameters, and test the detection performance of the DRSN.

9. The low SNR seismic detection model based on a DRSN according to claim 8, wherein when training the model, the batch size and maximum epoch are set, the cross-entropy error function was used to calculate the distance between the actual model output and label, and the network was optimized through adaptive moment estimation (learning rate=0.0001) to reduce the error function value, after repeated training and optimization trials, the error of the training result was minimized, the model converged, and the optimal model was obtained, the cross-entropy error is calculated using the following formula:
$$E = - {\sum }_{j = 1}^{n} {t}_{j} log ( {e}^{{x}_{j}} / {\sum }_{i = 1}^{n} {e}^{{x}_{i}} ) , \qquad ( 10 )$$
where xᵢ is the ith output feature map, tⱼ is the probability of the sample belonging to the jth class, n is the number of classes, E is the value of the cross-entropy error function,
upon completion of the training, the test set is employed to validate the constructed seismic event detection model.

10. The low SNR seismic detection model based on a DRSN according to claim 9, wherein to verify the detection performance of the DRSN under real low SNR signals, the present invention applied the model to detect microseismic events from the monitoring data of a shale gas development zone in southern Sichuan.
